(19) United States
(12) Patent Application Publication
(10) Pub. No.: US 2002/0176012 A1
(43) Pub. Date: Nov. 28, 2002

(54) Electronic script apparatus for television camera apparatus

(76) Inventor: Masayoshi Wasada, Saitama-shi (JP)

Correspondence Address: HARNESS, DICKEY & PIERCE, P.L.C., P.O. BOX 8910, RESTON, VA, 20195, US

(21) Appl. No.: 10/154,917

(22) Filed: May 28, 2002

(30) Foreign Application Priority Data
May 28, 2001 (JP) 2001-158838
May 29, 2001 (JP) 2001-160475

(51) Int. Cl. H04N 5/262

(52) U.S. Cl. 348/239

(57) ABSTRACT

The television camera apparatus to which the electronic script apparatus has been applied includes a viewfinder which displays a shot image. The viewfinder displays a double image of a shot image and a script image mixed together by a video selector. This enables a cameraman to read a script without turning his eyes away from the viewfinder. Further, pages in displayed script information can be turned over by pressing operation buttons disposed on a zoom rate demand acting as an operation section of the television camera apparatus. This enables the cameraman to turn over pages of the script while operating the television camera apparatus with his both hands.

### BACKGROUND OF THE INVENTION

1. Field of the Invention

The present invention relates to an electronic script apparatus for a television camera apparatus, and in particular, to an electronic script apparatus for a television camera apparatus which displays script information to be viewed by a cameraman.

2. Description of the Related Art

Conventional production of television programs involves scripts, which describes information to be communicated to viewers and how to communicate the information (a shooting procedure and a shooting method such as cutting). A cameraman operates a television camera apparatus according to the shooting method shown in the script to shoot images.

Now then, the television camera apparatus has a script holder mounted thereon to support a script so that it is open. While turning over and reading the pages of the script, fixed to the script holder, the cameraman alternately watches the script and a shot image displayed on a viewfinder to operate the television camera apparatus.

However, in the prior art, when the cameraman reads the script, his eyes are turned away from the viewfinder, thereby possibly delaying timings for zoom or focus operations.

Further, disadvantageously, the script, made of paper, may make a sound when the cameraman turns over the pages, or the cameraman may open the scrip at an incorrect page. Another problem is that when the cameraman uses both hands to operate the television camera apparatus, he cannot turn over the pages of the script.

Japanese Patent Application Publication No. 11-88828 discloses an electronic script apparatus which displays script information for narration in synchronization with recorded images. This electronic script apparatus displays the script information on a display device, thereby preventing a sound that may be made when the pages of a paper script are turned over and also preventing the cameraman from turning to the incorrect page.

However, even if the configuration of the electronic script apparatus described in Japanese Patent Application Publication No. 11-88828 is applied to a television camera apparatus, the problem that the cameraman cannot turn over the pages of the script during shooting cannot be solved.

### SUMMARY OF THE INVENTION

The present invention is achieved in view of these points, and it is an object thereof to provide an electronic script apparatus for a television camera apparatus which enables a cameraman to read a script without turning his eyes away from a viewfinder of the television camera apparatus. It is another object of the present invention to provide an electronic script apparatus for a television camera apparatus which enables the cameraman to turn over the pages of the script while using both hands to operate the television camera apparatus.

To attain these objects, the present invention is directed to an electronic script apparatus for a television camera apparatus provided with a viewfinder which displays a shot image, the electronic script apparatus comprising: a storage device which stores script information; and a processing device which executes a process for displaying, on the viewfinder, the script information stored in the storage device.

According to the present invention, the script information is displayed on the viewfinder of the camera, thereby enabling a cameraman to read the script information without turning his eyes away from the viewfinder.

Preferably, the processing device displays the shot image and the script information so that the image and the information overlap each other, thereby enabling the cameraman to simultaneously view the shot image and the script information.

Alternatively, the processing device can divide one screen into pieces in each of which one of the shot image and the script information is displayed, thereby enabling the cameraman to view the shot image and the script information within the same screen.

To attain the above objects, the present invention is also directed to an electronic script apparatus for a television camera apparatus, the electronic script apparatus comprising: a storage device which stores script information; a display device which displays the script information in the storage device; and an operation device which operates the script information displayed on the display device, the operation device being arranged on an operation section of the television camera apparatus.

According to the present invention, the operation device which operates the script information displayed on the display device is provided on the operation section of the television camera apparatus, thereby enabling the cameraman to operate the script information on the display device without taking his hands off the operation section of the television camera apparatus.

Preferably, the operation section is a zoom rate demand which causes the television camera apparatus to zoom or a focus position demand which operates a focus of the television camera apparatus, thereby enabling the cameraman to allow the television camera apparatus to perform a zoom or focus operation while operating the script information.

Preferably, the storage device, the display device, and the operation device of the script information are detachably mounted in the television camera apparatus as a single unit. Thus, the unit of the storage device, display device, and operation device can be detached from the television camera apparatus and carried to allow script information to be easily input.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a perspective view of a television camera apparatus to which an electronic script apparatus of a first embodiment has been applied;

FIG. 2 is a block diagram showing a configuration of the electronic script apparatus of the first embodiment;

FIGS. 3(A)-3(E) are waveform diagrams showing a double image forming operation;

FIG. 4 is a diagram showing an example of a double image display according to the first embodiment;

FIG. 5 is a block diagram showing a configuration of an electronic script apparatus of a second embodiment;

FIG. 6 is a diagram showing an example of a double image display according to the second embodiment;

FIG. 7 is a diagram showing an example of a double image display different from that in FIG. 6;

FIG. 8 is a diagram showing an example of a double image display different from that in FIG. 6;

FIG. 9 is a perspective view of a television camera apparatus to which an electronic script apparatus of a third embodiment has been applied;

FIG. 10 is a perspective view showing a zoom rate demand;

FIG. 11 is a block diagram showing the configuration of the electronic script apparatus;

FIG. 12 is a perspective view showing a zoom rate demand having an operation button installed at a position different from that in FIG. 10;

FIG. 13 is a perspective view showing a focus position demand with an operation button; and

FIG. 14 is a perspective view showing an electronic script unit having a display and an operation button integrated together.

### DETAILED DESCRIPTION OF THE PREFERRED EMBODIMENTS

Preferred embodiments of electronic script apparatuses for a television camera apparatus according to the present invention will be described below in detail with reference to the drawings.

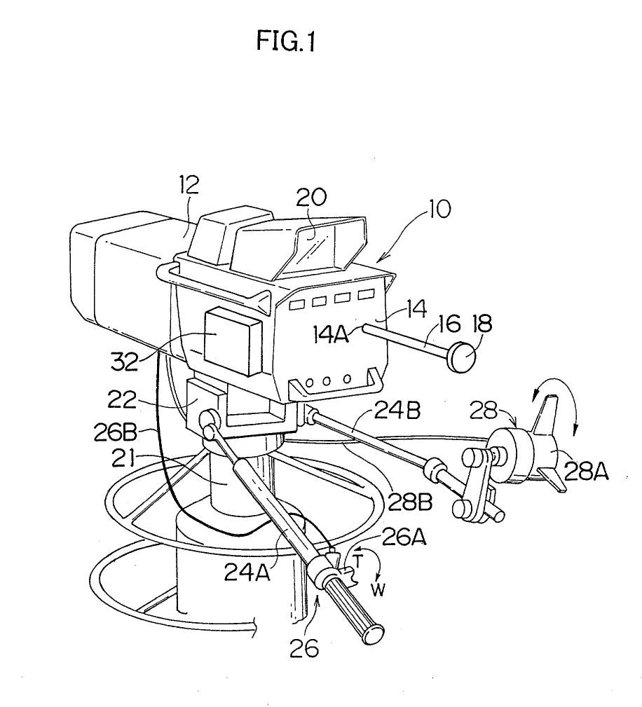

FIG. 1 shows a television camera apparatus 10 to which a first embodiment of an electronic script apparatus according to the present invention has been applied. The television camera apparatus 10 can perform zoom and focus operations on the basis of a uniaxial two-operation method and a servo operation method, and is mainly composed of an EFP lens device 12 and a camera main body 14.

The camera main body 14 is detachably mounted on a camera platform provided on top of a tripod or pedestal 21. An operation bar 16 is detachable from the lens device 12 and is disposed so as to penetrate the camera main body 14. The operation bar 16 is passed through an operation bar through-hole 14A formed in the camera main body 14. The operation bar 16 has a tip portion connected to a lens driving section (not shown) of the lens device 12.

While viewing a shot image displayed on a viewfinder 20 installed on top of the camera main body 14, shown in FIG. 1, a cameraman grips a grip 18 of the operation bar 16 and pushes and pulls the operation bar 16 to perform a zoom operation. The cameraman can also perform a focus adjustment by rotationally operating the grip 18 to rotate the operation bar 16. In this case, the operation bar 16 is detachable from the EFP lens device 12.

A zoom rate demand 26 and a focus position demand 28 can be installed on a pan and tilt bars 24A and 24B extended from the camera platform 22. The zoom rate demand 26 is provided with a rotationally movable thumb ring 26A which is rotationally operated using the cameraman's thumb. This causes a zoom speed instruction signal to be output depending on an operating direction and the quantity of operations, thereby performing a zoom operation. Further, the focus position demand 28 is provided with a rotationally movable focus knob 28A. The focus knob 28A is rotationally operated to output a focus position instruction signal depending on a rotationally moved position, thereby performing a focus operation. While viewing a shot image displayed on the viewfinder 20, the cameraman uses the zoom rate demand 26 to perform a zoom operation, while using the focus position demand 28 to perform a focus operation.

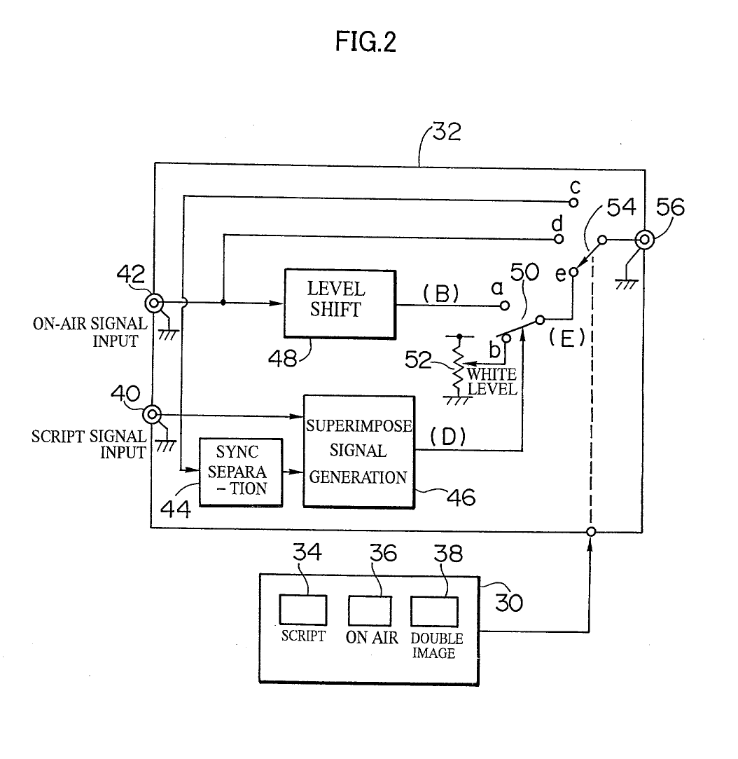

FIG. 2 is a block diagram showing a configuration of the electronic script apparatus.

As shown in this drawing, the electronic script apparatus is mainly composed of an operation section 30 and a video selector 32. The video selector 32 is detachably attached to the camera main body 14, as shown in FIG. 1. Further, the video selector 32 comprises an input terminal 40 for script video signals and an input terminal 42 for on-air video signals, as shown in FIG. 2. The input terminal 40 is connected to a sync separation circuit 44 and a superimpose signal generating circuit 46. The sync separation circuit 44 separates synchronization signals from script video signals. Further, the superimpose signal generating circuit 46 can form character superimpose signals of only the character portions of script images.

The input terminal 42 has a level shift circuit 48 connected thereto to reduce the amplitude of on-air video signals. The level shift circuit 48 and the superimposed signal generating circuit 46 are followed by a mixing circuit 50 which mixes these output signals together. The mixing circuit 50 is connected to a white level setter 52 which sets white level signals to mix superimpose signals, which are in white, into on-air video signals. The color of the superimpose signal is not limited to white.

The video selector 32 has an output terminal 56 having a switching circuit 45 connected thereto. The switching circuit 54 is switched by control signals from the operation section 30 so that any one of terminals c, d, and e is connected to an output terminal 56. Script video signals are supplied to the terminal c, on-air video signals are supplied to the terminal d, and double-image video signals mixed by the mixing circuit 50 are supplied to the terminal e.

The operation section 30 has switches 34, 36, and 38 which are pressed to switch the connection of the switching circuit 54 to the terminals c, d, and e, respectively. Accordingly, the output terminal 56 outputs either a script video signal or an on-air video signal or a double-image video signal, which is then transmitted to the viewfinder 20 in FIG. 1. Thus, the viewfinder 20 displays either a script image or a shot image or a mixture of a script and shot images.

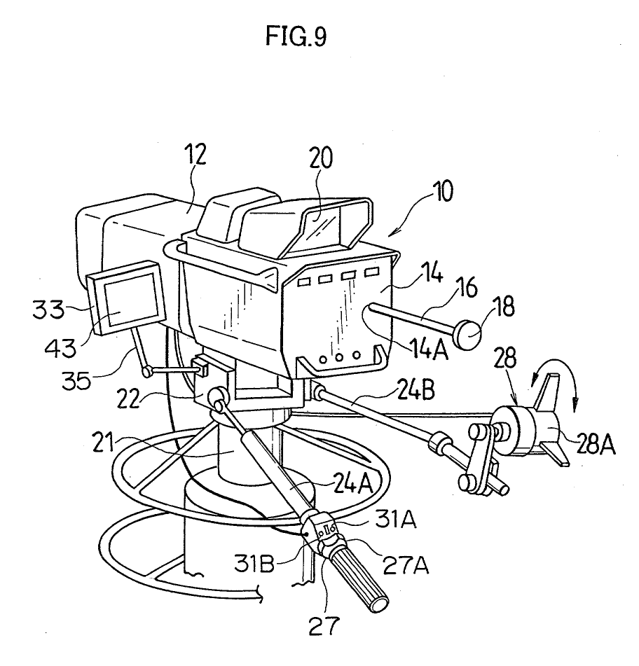

The switches 34, 36, and 38 of the operation section 30 are disposed on, for example, the zoom rate demand 26 or focus position demand 28 in FIG. 1. Thus, the cameraman can press the switch 34, 36, or 38 to switch the image without taking his hand off the zoom rate demand 26 or focus position demand 28. Switches may be disposed on the zoom rate demand 26 or focus position demand 28 to switch a page in a script image displayed on the viewfinder 20 or to scroll it upward, downward, rightward, or leftward (these switches correspond to operation buttons 31A and 31B, shown in FIGS. 9 to 14). Furthermore, a knob used to adjust white level may be disposed on the zoom rate demand 26 or focus position demand 28.

Next, the operation of the electronic script apparatus constructed as described above will be described.

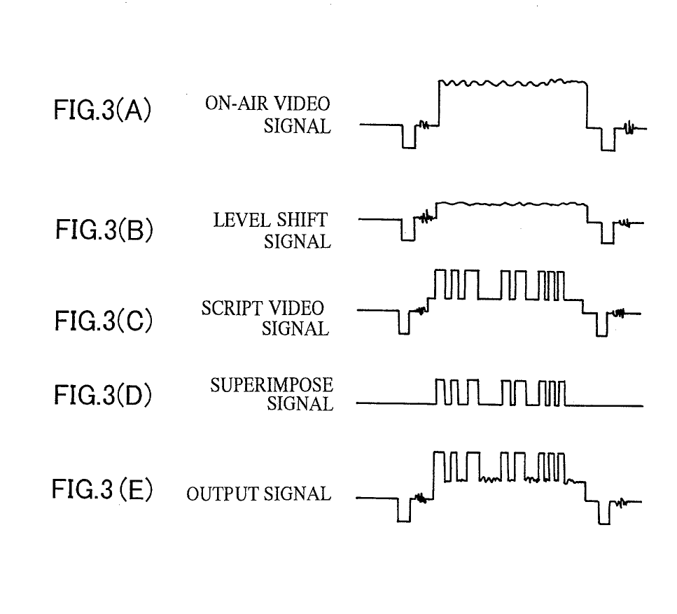

When the television camera apparatus 10 is used to shoot an image, an on-air video signal such as the one shown in FIG. 3(A) is supplied to the input terminal 42 of the video selector 32. This on-air video signal has its amplitude reduced by the level shift circuit 48 to become the signal shown in FIG. 3(B), i.e. a video signal in light gray which has a reduced luminance.

On the other hand, a script video signal such as the one shown in FIG. 3(C) is supplied to the input terminal 40 of the video selector 32. The script video signal is previously obtained by shooting script information using a camera or the like and is then stored in a storage device such as a memory. The script video signal input through the input terminal 40 is supplied to the superimpose signal generating circuit 46. Then, on the basis of a synchronizing signal from the sync separation circuit 44, a superimpose signal formed of only character portions can be obtained as shown in FIG. 3(D).

This superimpose signal and the air-on video signal are supplied to the mixing circuit 50. When the superimpose signal is high, a white level signal from the terminal b is superimposed on the on-video signal to output a video signal having two images mixed therein as shown in FIG. 3(E).

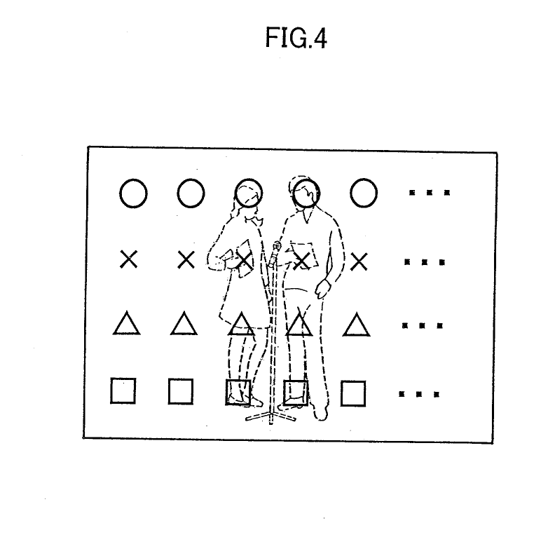

Consequently, when the switch 38 of the operation section 30 in FIG. 2 is pressed to connect the terminal e of the switching circuit 54, the mixing circuit 54 outputs a double-image video signal. Therefore, the viewfinder 20 in FIG. 1 displays a double image such as that shown in FIG. 4, i.e. a double image having a shot image and a script image superimposed on each other. Thereby, the cameraman can simultaneously view the shot image and the script image without turning his eyes away from the viewfinder 20.

Thus, according to the electronic script apparatus of this embodiment, the viewfinder 20 simultaneously displays the shot image and the script image, thereby enabling the cameraman to read the script without turning his eyes away from the viewfinder 20. Accordingly, while reading the script, the cameraman can promptly and precisely perform a zoom or focus operation. In particular, in this embodiment, the shot image and the script image are superimposed on each other and are thus displayed so as to cover the entire screen of the viewfinder 20, so that the cameraman can easily view the shot image and the script image.

In the above-described embodiment, when the switch 34 of the operation section 30 is pressed, the terminal c of the switching circuit 54 is connected to output a script video signal, thereby allowing only the script image to be displayed on the viewfinder 54. Further, when the switch 36 is pressed, the terminal d of the switching circuit 54 is connected to output an on-air video signal, thereby allowing only the shot image to be displayed on the viewfinder 20. Consequently, by alternately pressing the switches 34 and 36 of the operation section 30 to switch the image displayed on the viewfinder 20 between the script image and the shot image, the cameraman can view the script information and the shot image without turning his eyes away from the viewfinder 20.

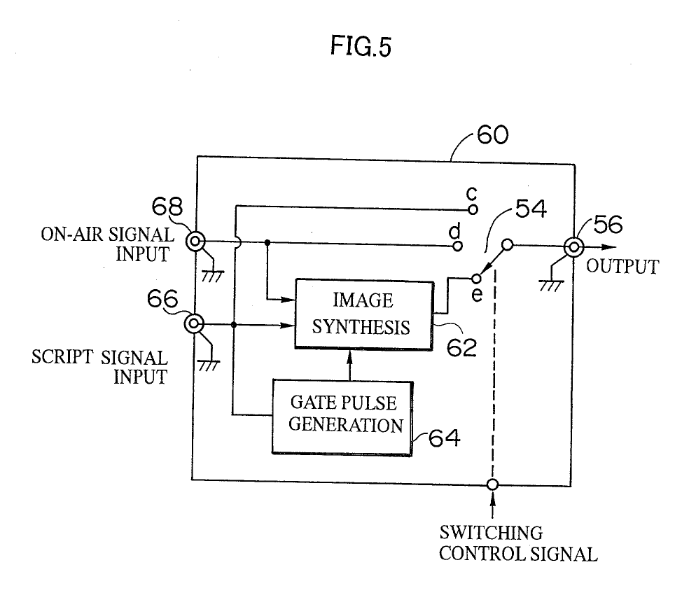

FIG. 5 shows a configuration of a second embodiment which forms a double image using a picture in picture method.

As shown in FIG. 5, a video selector 60 in the second embodiment is provided with a gate pulse generating circuit 62 and an image synthesizing circuit 64. Script video signals input through input terminals 66 and 68, respectively, are supplied to the image synthesizing circuit 64. A script video signal input through the input terminal 66 is supplied to the gate pulse generating circuit 62. The gate pulse generating circuit 62 forms a gate pulse which cuts out a part of the script image from a synchronizing signal separated from the script video signal. The gate pulse formed is supplied to the image synthesizing circuit 64.

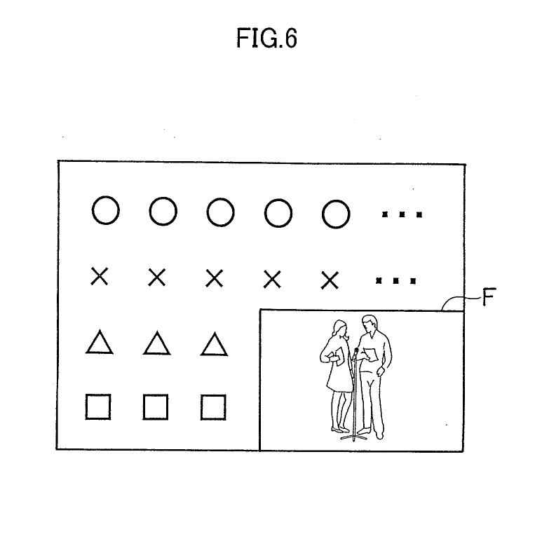

In the image synthesizing circuit 64, the gate pulse cuts out a predetermined area F (see FIG. 6) from the script image, and a reduced shot image formed from the on-air video signal is fitted in the area F to form a picture-in-picture double image. Then, when the terminal e of the switching circuit 54 is connected, the double image signal provided by the image synthesizing circuit 64 is supplied to the viewfinder 20 (see FIG. 1) through the output terminal 56. Thus, the viewfinder displays a picture-in-picture double image such as the one shown in FIG. 6, i.e. simultaneously displays the script image and the shot image. Therefore, the cameraman can read the script image without turning his eyes away from the viewfinder 20. In the second embodiment, scrolling the script image upward, downward, rightward, or leftward enables display of part of the script image which is hidden behind the area F.

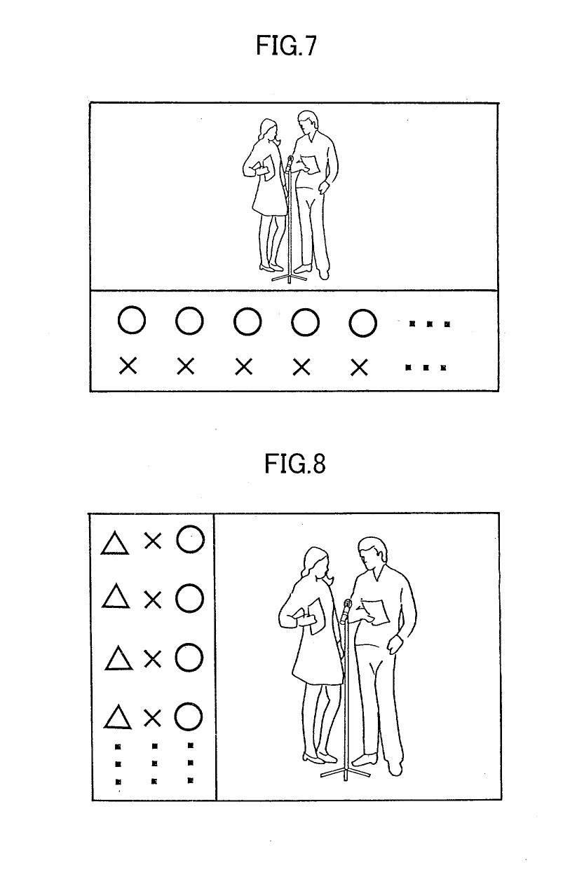

An example of a double image in the second embodiment is not limited to the image shown in FIG. 6, but a double image may be displayed, for example, as shown in FIG. 7 or 8. In FIG. 7, the script image is horizontally divided into two, and the upper part obtained is cut out, with the vertically compressed shot image fitted in this part. Further, in FIG. 8, the script image is vertically divided into two, and the right part obtained is cut out, with the horizontally compressed shot image fitted in this part.

FIG. 9 shows a television camera apparatus 11 to which a third embodiment of an electronic script apparatus according to the present invention has been applied. The television camera apparatus 11 differs from the one 10 shown in FIG. 1, in the zoom rate demand 27 and display 33. Those members of the television camera apparatus 11 which have functions similar to those of the corresponding members of the television camera 10 apparatus in FIG. 1 are denoted by the same reference numerals, and description thereof is omitted.

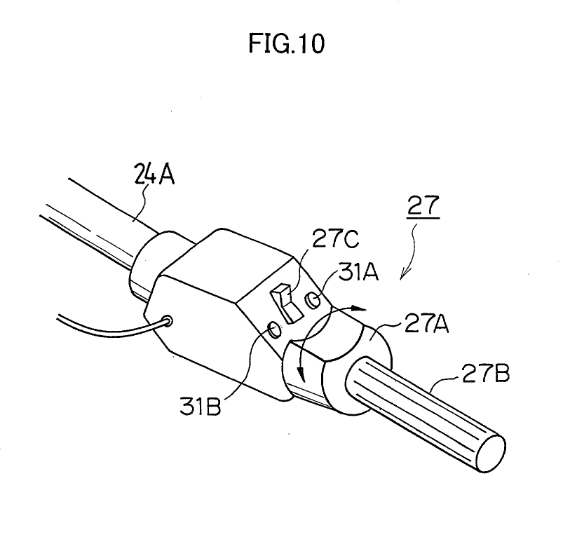

As shown in FIG. 10, the zoom rate demand 27 has a grip 27B provided with a rotationally movable thumb ring 27A at the position of the thumb established when the grip 27B is gripped. When the cameraman uses his thumb to rotationally operate the thumb ring 27A, a zoom speed instruction signal is output depending on an operating direction and the quantity of operations, thereby performing a zoom operation.

Further, the zoom rate demand 27 is provided with an intercom switch 27C adjacent to the thumb ring 27A. The intercom switch 27C causes an alternate or momentary lock function to be provided depending on the direction in which the switch is tilted. The intercom switch 27C functions as a microphone switch used to turn on and off a communication microphone for communications between the cameraman and a conditioning room.

Operation buttons 31A and 31B for the electronic script apparatus are provided at the respective sides of the intercom switch 27C. When the operation button 31A or 31B is pressed, a page in the script information displayed on the display 33 in FIG. 9 is turned over. That is, pressing the operation button 31A switches the page in the script information to the following one. Pressing the operation button 31B switches the page in the script information to the preceding one. The operation performed on the script information using the operation buttons 31A and 31B is not limited to turning-over of the pages but may be scrolling-upward, -downward, -rightward, and -leftward of the script information being displayed.

As shown in FIG. 9, the display 33 is attached to the camera platform 22 via an arm 35. The arm 35 has a link mechanism to three-dimensionally adjust the position of the display 33. Thus, a display screen 43 of the display 33 can be adjusted at such a position that the cameraman can easily view the screen.

Further, the display 33 is detachably attached to the tip of the arm 35. Accordingly, the display 33 can be detached from the arm 35 and carried so that script information or the like can be input thereto.

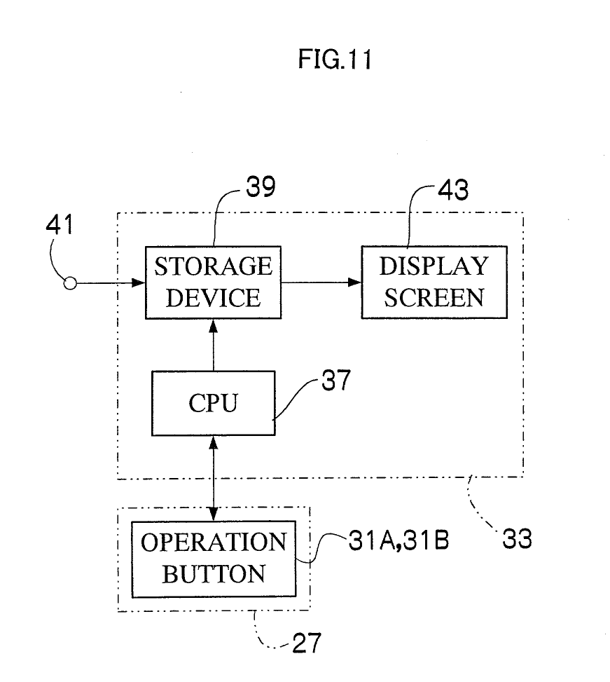

As shown in FIG. 11, the display 33 contains a CPU 37 and a storage device 39 such as a memory which has script information stored therein. As script information, a video signal obtained by shooting a paper script using a script camera or text information from a word processor is input through the input terminal 41 and stored in the storage device 39. When the operation button 31A or 31B is operated, the CPU 37 outputs a control signal to the storage device 39. Thus, the script information stored in the storage device 39 is output to the display screen 43, which then displays it.

The script information stored in the storage device can be changed by displaying it on the display screen 43 and then writing additional items thereto using a touch pen (not shown).

Next, description will be given of the operation of the electronic script apparatus constructed as described above.

During shooting, the cameraman grips the zoom rate demand 27 with his left hand, while gripping the focus position demand 29 with his right hand. Then, the cameraman reads the script information displayed on the display 33, and performs a zoom operation with his left hand and a focus operation with his right hand according to the shooting method shown in the script information.

At this time, once the cameraman finishes reading the script information displayed on the display 33, he presses the button 31A or 31B to switch the page in the script information displayed on the display 33. Since the operation buttons 31A and 31B are provided on the zoom rate demand 27, the cameraman can press the operation button 31A or 31B without taking his left hand off the zoom rate demand 27. Accordingly, the cameraman can read the script while using both hands to allow the television camera apparatus 11 to perform a zoom or focus operation.

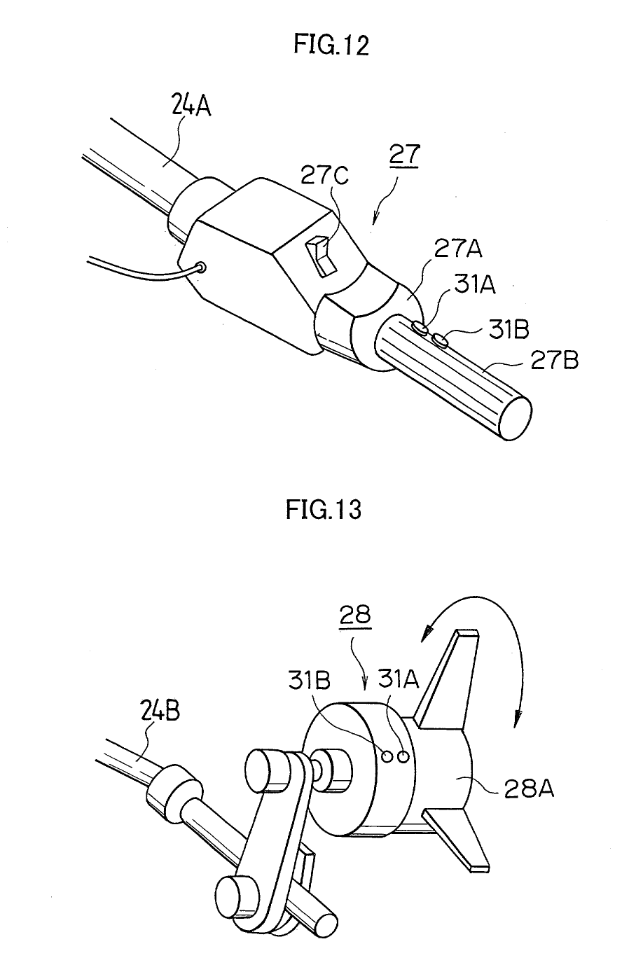

The positions where the operation buttons 31A and 31B are installed are not limited to those in the above-described embodiments. For example, the operation buttons 31A and 31B may be provided on the grip 27B of the zoom rate demand 27 as shown in FIG. 12, so that the cameraman can operate the operation buttons 31A and 31B with his finger different from his thumb (for example, his forefinger).

Further, as shown in FIG. 13, the operation buttons 31A and 31B may be provided on the focus position demand 28. Thus, while rotationally operating the focus knob 28A, the cameraman can turn over the pages of the script.

Further, the operation buttons 31A and 31B may be provided on the grip 18 or the like of the operation bar 16, shown in FIG. 9.

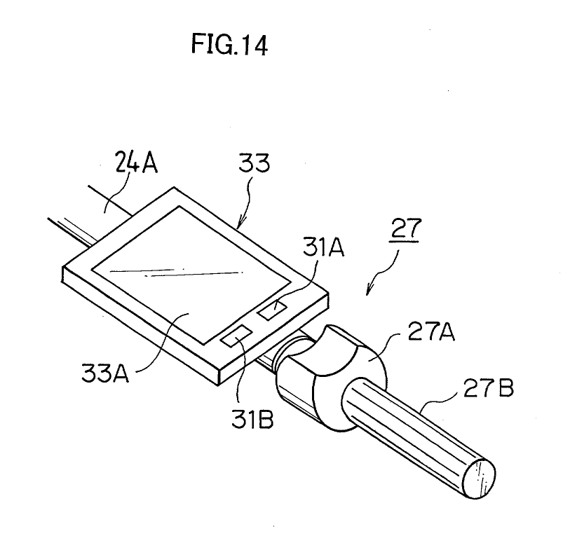

As shown in FIG. 14, the operation buttons 31A and 31B may be provided on the display 33 to form a single unit, which may be mounted on the operation section of the zoom rate demand 27 or the like. In this case, when the unit is detachably installed in the television camera apparatus 11, it can be detached from the television camera apparatus 11 and easily carried, and script information can be easily input thereto. Furthermore, when the display 33 is provided with an image pickup device such as a CCD, script information can be directly loaded into the display 33.

As described above, the electronic script apparatus for a television camera apparatus according to the present invention allows script information to be displayed on the viewfinder together with a shot image, thereby enabling the cameraman to view the shot image and the script information without turning his eyes away from the viewfinder.

Further, in the electronic script apparatus for a television camera apparatus according to the present invention, the operation device operating script information displayed on the display device is provided on the operation section of the television camera apparatus, thereby enabling the cameraman to operate script information displayed on the display device without taking his hand off the operation section of the television camera apparatus.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An electronic script apparatus for a television camera apparatus provided with a viewfinder which displays a shot image, the electronic script apparatus comprising:
a storage device which stores script information; and
a processing device which executes a process for displaying, on the viewfinder, the script information stored in the storage device.

2. The electronic script apparatus according to claim 1, wherein the processing device displays the shot image and the script information so that the image and the information overlap each other.

3. The electronic script apparatus according to claim 1, wherein the processing device divides one screen into pieces in each of which one of the shot image and the script information is displayed.

4. An electronic script apparatus for a television camera apparatus, the electronic script apparatus comprising:
a storage device which stores script information;
a display device which displays the script information in the storage device; and
an operation device which operates the script information displayed on the display device, the operation device being arranged on an operation section of the television camera apparatus.

5. The electronic script apparatus according to claim 4, wherein the operation section is one of a zoom rate demand which causes the television camera apparatus to zoom and a focus position demand which operates a focus of the television camera apparatus.

6. The electronic script apparatus according to claim 4, wherein the storage device, the display device, and the operation device are detachably mounted in the television camera apparatus as a single unit.
